(19) United States
(12) Patent Application Publication
(10) Pub. No.: US 2011/0131630 A1
(43) Pub. Date: Jun. 2, 2011

(54) SERVICE ACCESS METHOD AND DEVICE, SERVICE AUTHENTICATION DEVICE AND TERMINAL BASED ON TEMPORARY AUTHENTICATION

(75) Inventors: Dong Guk JE, Daejeon (KR); Tae Yeon KIM, Daejeon (KR); Ho Young SONG, Daejeon (KR); Nam Kyoung UM, Chungcheongbuk-do (KR)

(73) Assignee: Electronics and Telecommunications Research Institute, Daejeon (KR)

(21) Appl. No.: 12/856,074

(22) Filed: Aug. 13, 2010

(30) Foreign Application Priority Data
Dec. 1, 2009 (KR) 10-2009-0117613

(51) Int. Cl. G06F 21/20

(52) U.S. Cl. 726/3

(57) ABSTRACT

A service access method and device, a user authentication device, and a terminal are provided. A service access method includes requesting a terminal to transmit authentication information in response to a service access request that is received from the terminal, receiving the authentication information from the terminal, permitting a temporary access to the terminal based on a result of a temporary authentication performed based on the authentication information, and processing a main authentication based on the authentication information.

### CROSS-REFERENCE TO RELATED APPLICATION

This application claims the benefit of Korean Patent Application No. 10-2009-0117613, filed on Dec. 1, 2009, in the Korean Intellectual Property Office, the disclosure of which is incorporated herein by reference.

### BACKGROUND

1. Field of the Invention

The present invention relates to a service access method and device, a user authentication device, and a terminal, and more particularly, to a service access method and device, a user authentication device, and a terminal that may use a temporary authentication.

2. Description of the Related Art

Conventionally, when user terminals are individually connected to telephone offices, telephone services are generally available even though authentications for users or terminals are not performed. However, with the emergence of new services, such as superhighway communication services or wireless Internet services, stronger authentication schemes for users or terminals have been required.

For example, in a typical authentication scheme, when authentication information is stored in a centralized authentication server, and when an access request is received from a user terminal, the authentication information may be transferred to another authentication server, and the user terminal may be authenticated based on the authentication information, so that the access request may be permitted. However, in this example, inefficient and long procedures, and a significant amount of time may be required to perform the authentication scheme. Additionally, authentication procedures may be performed selectively for only an expensive access service that has a significant delay in response, for example an Internet service access service, instead of being performed for each unit service.

### SUMMARY

An aspect of the present invention provides a service access method and device, a user authentication device, and a terminal that may permit a temporary access based on a temporary authentication, to reduce loads in an authentication device.

Another aspect of the present invention provides a service access method and device, a user authentication device, and a terminal that may control presence or absence of a main authentication based on a service type through a temporary authentication, to reduce a service access time, and to prevent unnecessary waste of resources.

According to an aspect of the present invention, there is provided a service access method including requesting a terminal to transmit authentication information in response to a service access request that is received from the terminal, receiving the authentication information from the terminal, permitting a temporary access to the terminal based on a result of a temporary authentication that is performed based on the authentication information, and processing a main authentication based on the authentication information.

The permitting of the temporary access may include transmitting an access rejection message (or signal) to the terminal when the temporary authentication fails, and permitting the temporary access to the terminal and transmitting a temporary access request to a service providing device when the temporary authentication succeeds.

The processing of the main authentication may include permitting a main access to the terminal based on a result of the main authentication performed based on the authentication information.

The permitting of the main access may maintain the temporary access.

The processing of the main authentication may further include revoking the temporary access when the main authentication fails.

The processing of the main authentication may further include transmitting a main authentication request to a user authentication device using the authentication information, and permitting the main access to the terminal based on a result of the main authentication. Here, the result of the main authentication may be received from the user authentication device.

The user authentication device may perform the main authentication using the authentication information. When the main authentication fails, the user authentication device may transmit a request to revoke the temporary access to the service providing device.

The processing of the main authentication may further include transmitting a main authentication request to the user authentication device using an authentication information group containing the authentication information, and permitting the main access to the terminal based on a result of the main authentication. Here, the result of the main authentication may be received from the user authentication device.

According to another aspect of the present invention, there is provided a terminal including a transceiver to transmit an access request and authentication information to a service access device, and a service processor to perform a temporary access in response to a permission of a temporary access request, and to perform a main access in response to a permission of a main access request. Here, the temporary access request and the main access request may be received from the service access device.

According to another aspect of the present invention, there is provided a user authentication device that performs a main authentication using authentication information received from a service access device, and transmits a result of the main authentication to the service access device. The service access device may permit a temporary access to a terminal based on a result of a temporary authentication performed based on the authentication information, and may request the main authentication using the authentication information.

### EFFECT

According to embodiments of the present invention, it is possible to permit a temporary access based on a temporary authentication, to reduce loads in an authentication device.

Additionally, according to embodiments of the present invention, it is possible to control presence or absence of a main authentication depending on a service type through a temporary authentication, to reduce a service access time, and to prevent unnecessary waste of resources.

Furthermore, according to embodiments of the present invention, it is possible to reduce an overall load by reducing time and effort(*“calculations”/“procedures”/“operations”/“computational costs”?*) required for authentication, and to further increase a user familiarity to a service by initiating the service prior to completion of an overall authentication.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a relationship between a service access device, a user authentication device, a service providing device, and a terminal, according to an embodiment of the present invention;

FIG. 2 is a flowchart illustrating a service access method according to an embodiment of the present invention;

FIG. 3 is a flowchart illustrating a service access method according to an embodiment of the present invention, in further detail; and

FIG. 4 is a block diagram illustrating a configuration of a terminal according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

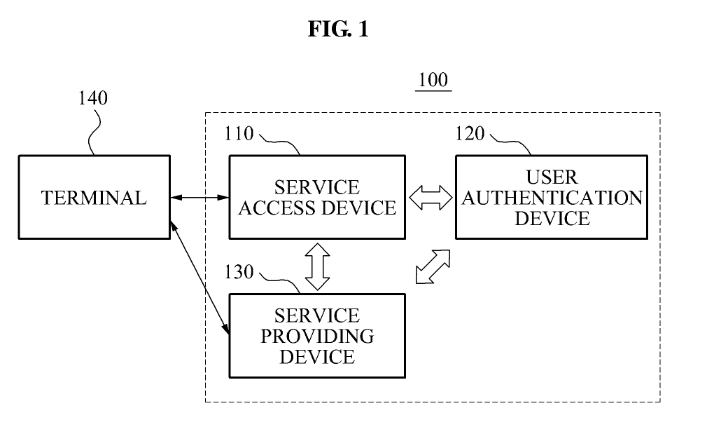

FIG. 1 is a block diagram illustrating a relationship between a service access device 110, a user authentication device 120, a service providing device 130, and a terminal 140, according to an embodiment of the present invention.

The service access device 110 of FIG. 1 may request the terminal 140 to transmit authentication information, in response to an access request received from the terminal 140. The service access device 110 may transmit the authentication information to the user authentication device 120, and simultaneously request an authentication of the terminal 140. The user authentication device 120 may perform the authentication of the terminal 140 based on the authentication information. When the authentication of the terminal 140 fails, the user authentication device 120 may reject an access request of the terminal 140. When the authentication of the terminal 140 succeeds, the user authentication device 120 may accept the access request of the terminal 140. Additionally, in response to the success of the authentication, the terminal 140 may attempt to access to the service providing device 130 and may perform a communication service.

According to an embodiment of the present invention, the authentication may include a temporary authentication and a main authentication. Specifically, the service access device 110 may perform a temporary authentication of the terminal 140 based on the authentication information, and may permit a temporary access to the terminal 140 based on a result of the temporary authentication. Additionally, the service access device 110 may accumulate pieces of authentication information, and may transmit the accumulated pieces of authentication information to the user authentication device 120. The user authentication device 120 may process a main authentication of the terminal 140 using the accumulated pieces of authentication information, and may accept or reject a main access request for the terminal 140 based on a result of processing the main authentication.

Additionally, according to an embodiment of the present invention, the service access device 110, the user authentication device 120, and the service providing device 130 may be included in a service providing system 100, as shown in FIG. 1. Here, the service providing system 100 may be implemented as a system operated and managed by a service provider, and may include, for example, a server device operated by a service provider. According to another embodiment of the present invention, the service access device 110, the user authentication device 120, and the service providing device 130 may be implemented individually as modules in a single device. Conversely, according to still another embodiment of the present invention, the service access device 110, the user authentication device 120, and the service providing device 130 may be respectively implemented as devices or servers that are independently installed so that they are relatively far apart from each other. For example, the service access device 110 may be built in a user terminal, or in an equipment within user's space, such as a home or office. In this example, the service access device 110 may perform a temporary authentication, prior to communication with an external source, to prevent additional costs from being incurred.

According to an embodiment of the present invention, the service access device 110 may request a terminal to transmit authentication information in response to a service access request that is received from the terminal, may receive the authentication information from the terminal, may permit a temporary access to the terminal based on a result of a temporary authentication performed based on the authentication information, and may process a main authentication based on the authentication information.

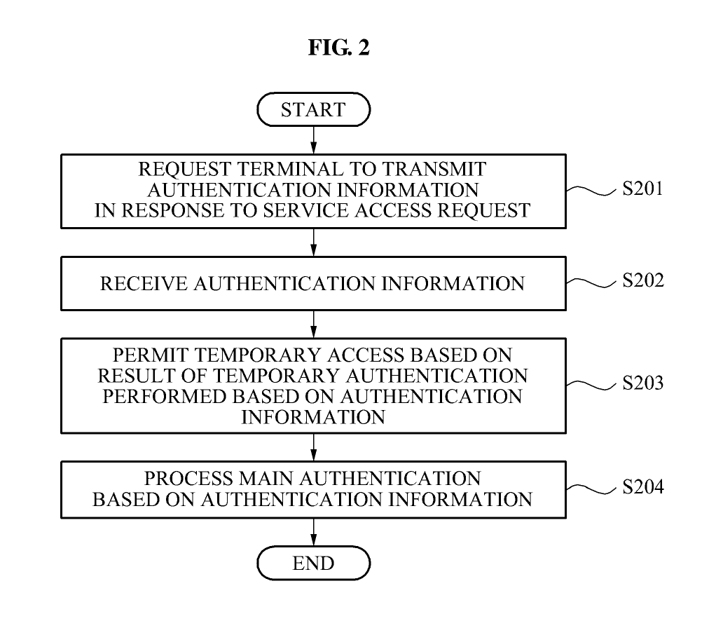

Hereinafter, a method of operating the service access device 110, the user authentication device 120, the service providing device 130, and the terminal 140 will be further described with reference to FIGS. 2 through 4.

FIG. 2 is a flowchart illustrating a service access method according to an embodiment of the present invention.

As shown in FIG. 2, the service access method includes operations S201 through S204. Here, operations S201 through S204 may be performed by the service access device 110.

In operation S201, the service access device 110 may request the terminal 140 to transmit authentication information, in response to a service access request received from the terminal 140.

In operation S202, the service access device 110 may receive the authentication information from the terminal 140.

In operation S203, the service access device 110 may permit a temporary access based on a result of a temporary authentication performed based on the authentication information. Specifically, when the temporary authentication fails, the service access device 110 may transmit an access rejection message to the terminal 140. When the temporary authentication succeeds, the service access device 110 may permit the temporary access to the terminal 140, and may transmit a temporary access request to the service providing device 130.

Here, the temporary authentication may be a validation procedure performed using all or a part of the authentication information. In other words, the temporary authentication may be performed without a limitation to simple information stored in the user authentication device 120, for example user information or a user password.

According to an embodiment of the present invention, the service access device 110 may perform the temporary authentication based on a validation code that is inserted into the authentication information. For example, the validation code may be inserted into the authentication information in compliance with an appointment made in advance, and the service access device 110 may perform the temporary authentication based on the validation code and thus, it is possible to prevent in advance a meaningless access using a data generation program. Additionally, the service access device 110 may perform the temporary authentication based on a random number table that is shared with the terminal 140.

In operation S204, the service access device 110 may process a main authentication based on the authentication information. Specifically, the service access device 110 may permit a main access to the terminal 140 based on a result of the main authentication performed based on the authentication information. Here, the permitting of the main access may maintain the temporary access. Conversely, when the main authentication fails, the service access device 110 may revoke the temporary access.

Additionally, the service access device 110 may transmit a main authentication request to the user authentication device 120 using the authentication information, and may permit the main access to the terminal 140 based on a result of the main authentication. Here, the result of the main authentication may be received from the user authentication device 120. The user authentication device 120 may perform the main authentication using the authentication information and, when the main authentication fails, may transmit a request to revoke the temporary access to the service providing device 130.

Specifically, the user authentication device 120 may perform the main authentication using authentication information of the terminal 140 that is received from the service access device 110, and may transmit a result of the main authentication to the service access device 110. Subsequently, the service access device 110 may permit a temporary access to the terminal 140 based on a result of a temporary authentication performed based on the authentication information, and may request the main authentication using the authentication information. Additionally, the service access device 110 may transmit the main authentication request using an authentication information group containing the authentication information, and may permit a main access to the terminal 140 based on a result of the main authentication.

Furthermore, the service access device 110 may transmit the main authentication request to the user authentication device 120 using the authentication information group containing the authentication information, and may permit the main access to the terminal 140 based on the result of the main authentication that is received from the user authentication device 120. In other words, the service access device 110 may transmit, to the user authentication device 120, an authentication information group that contains accumulated pieces of authentication information, and the user authentication device 120 may process the accumulated pieces of authentication information, which may result in efficient processing and reduction in loads.

According to an embodiment of the present invention, the temporary authentication may be a terminal authentication, and the main authentication may be a user authentication. Specifically, the service access device 110 may perform a terminal authentication for the terminal 140 based on the authentication information to process the temporary authentication, and may perform a user authentication for the terminal 140 to process the main authentication.

Specifically, as an example of the user authentication, when the service access device 110 receives a user ID and password as the authentication information, a value obtained by accumulating American Standard Code for Information Interchange (ASCII) values of a password field based on a user ID naming rule and by repeatedly adding each place value may be added to an end of the password field, so that a resulting value may be used as a validation code. Additionally, as an example of the terminal authentication, the terminal 140 may transmit, to the service access device 110, a random number along with a time the random number was generated. Here, the random number may be generated by setting time information as a seed using the stored random number table. The service access device 110 may verify the random number based on the random number table shared with the terminal 140.

The service access device 110 may validate a Media Access Control (MAC) address for the terminal 140, may perform a temporary authentication, and may perform a main authentication using a user ID and password. Here, when the terminal 140 is powered on, a user may be provided with a predetermined service through a temporary access. Accordingly, it is possible to provide the user with a simple push service, such as a notification or guidance information, prior to the main authentication.

Moreover, the service access device 110 may identify a type of the service, and may determine whether to perform the temporary authentication based on the identified type. For example, when the service is identified as a critically important service, the service access device 110 may omit the temporary authentication. Conversely, when the service is identified as a less important service, the service access device 110 may permit an access to only service guide information through the temporary authentication.

In addition, the service access device 110 may determine a frequency of service access requests, and may determine whether to perform the temporary authentication based on a result of the determining. Specifically, the service access device 110 may control a number of the pieces of authentication information contained in the authentication information group, based on the frequency of the service access requests. For example, when the user authentication device 120 is idle, the service access device 110 may transfer an authentication request without delay, and the user authentication device 120 may quickly perform an authentication. Conversely, when a large number of authentications are requested, the service access device 110 may accumulate pieces of received authentication information until a number of the accumulated pieces of authentication information reaches a predetermined threshold, and may collectively transfer the accumulated pieces of authentication information to the user authentication device 120. Thus, the service access device 110 may improve authentication efficiency, and may reduce an amount of control messages.

According to an embodiment of the present invention, the temporary access may be requested and permitted through the same message as the main access. Here, when an access permission message and an access request message are transmitted simultaneously, the terminal 140 and the service providing device 130 may ignore both of the messages.

Additionally, the permitting of the main access may maintain the temporary access. Specifically, since a temporary access connection may be identical to a main access connection, the main access connection may be omitted, and instead the temporary access connection may be maintained.

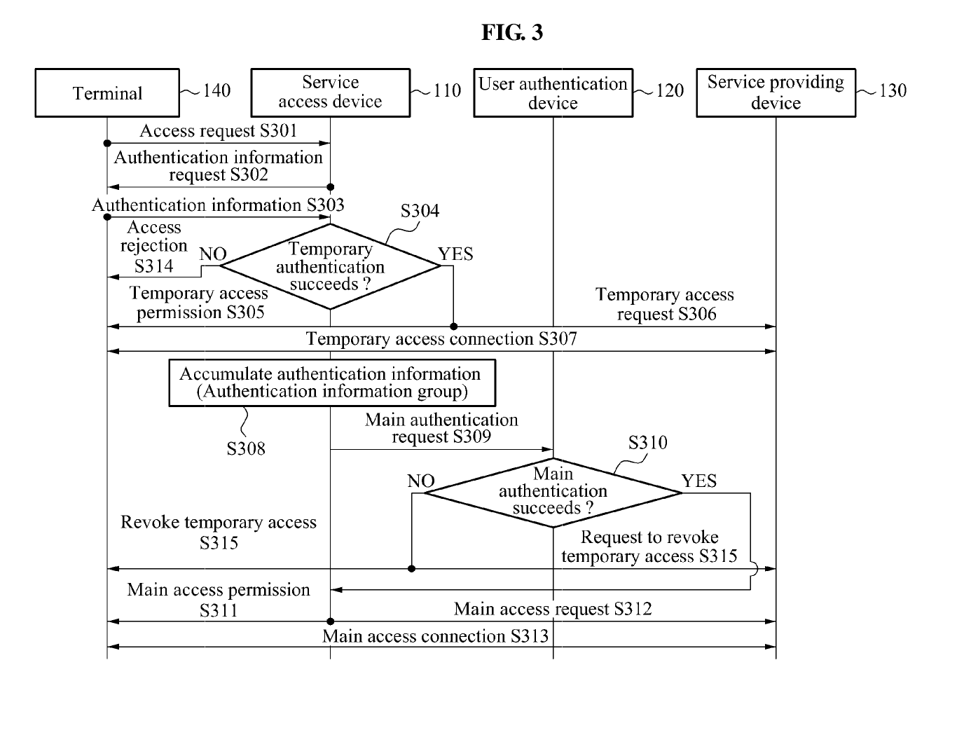

FIG. 3 is a flowchart illustrating a service access method according to an embodiment of the present invention, in further detail.

The terminal 140 may transmit a service access request to the service access device 110 in operation S301.

In response to the service access request, the service access device 110 may request the terminal 140 to transmit authentication information in operation S302, and may receive the authentication information from the terminal 140 in operation S303.

In operation S304, the service access device 110 may perform a temporary authentication based on verifiable data among the authentication information, prior to a main authentication in the user authentication device 120. When the temporary authentication fails, the service access device 110 may transmit an access rejection message to the terminal 140, and may terminate the authentication in operation S314. Conversely, when the temporary authentication succeeds, the service access device 110 may transmit a temporary access permission to the terminal 140 in operation S305, and may transmit a temporary access request to the service providing device 130 in operation S306. Subsequently, the terminal 140 may perform a temporary access connection with the service providing device 130 in operation S307. Here, the temporary access connection may be a service.

The service access device 110 may accumulate pieces of authentication information that are associated with service requests prior to the main authentication, in operation S308, and may transmit, to the user authentication device 120, the accumulated pieces of authentication information along with a main authentication request in operation S309. Subsequently, the user authentication device 120 may perform a main authentication based on user authentication information that is registered in advance, in operation S310. When the main authentication fails, the user authentication device 120 may request the service access device 110 to revoke the temporary access, and the service access device 110 may revoke the temporary access and may terminate the authentication in operation S315. Conversely, when the main authentication succeeds, the user authentication device 120 may transmit a result of the main authentication to the service access device 110, and the service access device 110 may permit a main access to the terminal 140 in operation S311, and may transmit a main access request for the terminal 140 to the service providing device 130 in operation S312. Additionally, the terminal 140 may perform a main access connection to the service providing device 130 based on access information, so that a communication service may be provided in operation S313.

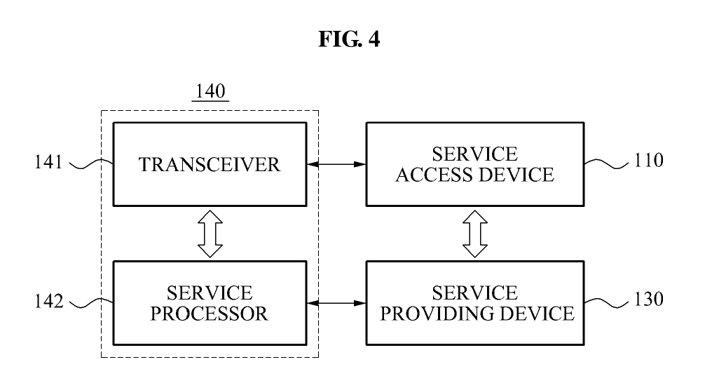

FIG. 4 is a block diagram illustrating a configuration of the terminal 140 according to an embodiment of the present invention.

As shown in FIG. 4, the terminal 140 includes a transceiver 141, and a service processor 142.

The transceiver 141 may transmit authentication information and an access request to the service access device 110.

The service processor 142 may perform a temporary access in response to a permission of a temporary access request received from the service access device 110, and may perform a main access in response to a permission of a main access request received from the service access device 110. Specifically, the service access device 110 may permit the temporary access to terminal 140 based on a result of a temporary authentication performed based on the authentication information, and may process a main authentication using the authentication information. Additionally, the service access device 110 may permit the main access based on a result of the main authentication performed based on the authentication information. Here, the permitting of the main access may maintain the temporary access.

Furthermore, the service access device 110 may transmit a main authentication request to the user authentication device 120 using the authentication information, and may permit the main access based on the result of the main authentication that is received from the user authentication device 120.

Details other than those described above with respect to the terminal 140 of FIG. 4 may be similar to those described above with reference to FIGS. 1 through 3, or may be easily inferred by those skilled in the art based on those described above, and accordingly, further description thereof will be omitted herein.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A service access method, comprising:
requesting a terminal to transmit authentication information in response to a service access request, the service access request being received from the terminal;
receiving the authentication information from the terminal;
permitting a temporary access to the terminal based on a result of a temporary authentication, the temporary authentication being performed based on the authentication information; and
processing a main authentication based on the authentication information.

2. The service access method of claim 1, wherein the permitting of the temporary access comprises transmitting an access rejection message to the terminal, when the temporary authentication fails.

3. The service access method of claim 1, wherein the permitting of the temporary access comprises permitting the temporary access to the terminal and transmitting a temporary access request to a service providing device, when the temporary authentication succeeds.

4. The service access method of claim 1, wherein the processing of the main authentication comprises permitting a main access to the terminal based on a result of the main authentication performed based on the authentication information.

5. The service access method of claim 4, wherein the permitting of the main access maintains the temporary access.

6. The service access method of claim 4, wherein the processing of the main authentication further comprises revoking the temporary access when the main authentication fails.

7. The service access method of claim 4, wherein the processing of the main authentication further comprises transmitting a main authentication request to a user authentication device using the authentication information, and permitting the main access to the terminal based on a result of the main authentication, the result being received from the user authentication device.

8. The service access method of claim 7, wherein the user authentication device performs the main authentication using the authentication information, and transmits a request to revoke the temporary access to the service providing device when the main authentication fails.

9. The service access method of claim 4, wherein the processing of the main authentication further comprises transmitting a main authentication request to the user authentication device using an authentication information group containing the authentication information, and permitting the main access to the terminal based on a result of the main authentication, the result being received from the user authentication device.

10. The service access method of claim 1, wherein the temporary authentication is performed based on a validation code, the validation code being inserted into the authentication information.

11. The service access method of claim 1, wherein the temporary authentication is performed based on a random number table, the random number table being shared with the terminal.

12. The service access method of claim 1, wherein the temporary authentication comprises a terminal authentication, and the main authentication comprises a user authentication.

13. The service access method of claim 1, wherein the permitting of the temporary access comprises identifying a type of a service, and determining whether to perform the temporary authentication based on the identified type.

14. The service access method of claim 1, wherein the permitting of the temporary access comprises determining a frequency of service access requests, and determining whether to perform the temporary authentication based on a result of the determining.

15. A terminal, comprising:
a transceiver to transmit an access request and authentication information to a service access device; and
a service processor to perform a temporary access in response to a permission of a temporary access request, and to perform a main access in response to a permission of a main access request, the temporary access request and the main access request being received from the service access device,
wherein the service access device permits the temporary access to the terminal based on a result of a temporary authentication performed based on the authentication information, and processes a main authentication using the authentication information.

16. The terminal of claim 15, wherein the service access device permits a main access based on a result of the main authentication performed based on the authentication information.

17. The terminal of claim 16, wherein the permitting of the main access maintains the temporary access.

18. The terminal of claim 16, wherein the service access device transmits a main authentication request to a user authentication device using the authentication information, and permits the main access based on a result of the main authentication, the result being received from the user authentication device.

19. A user authentication device to perform a main authentication using authentication information, and to transmit a result of the main authentication to a service access device, the authentication information being received from the service access device,
wherein the service access device permits a temporary access to a terminal based on a result of a temporary authentication performed based on the authentication information, and requests the main authentication using the authentication information.

20. The user authentication device of claim 19, wherein the service access device transmits a main authentication request to the user authentication device using an authentication information group containing the authentication information, and permits a main access to the terminal based on the result of the main authentication.
